(19) United States
(12) Patent Application Publication
(10) Pub. No.: US 2024/0386419 A1
(43) Pub. Date: Nov. 21, 2024

(54) ONE TIME DEBIT CARD FOR CRYPTOCURRENCY TRANSFER IN THE METAVERSE

(71) Applicant: Bank of America Corporation, Charlotte, NC (US)

(72) Inventor: Heather Dolan, Sarasota, FL (US)

(21) Appl. No.: 18/199,467

(22) Filed: May 19, 2023

(51) Int. Cl. G06Q 20/38; G06Q 20/06; G06Q 20/36

(52) U.S. Cl. CPC G06Q 20/381; G06Q 20/065; G06Q 20/36

(57) ABSTRACT

Systems and methods for transferring currency in the metaverse. Methods may include a payment API of a financial institution operating in the metaverse receiving a request to transfer fiat currency between two parties in the metaverse, where the receiving party may be unbanked. Methods may include the payment API receiving the fiat currency from the transmitting party and funding a virtual account with the received fiat currency, where the virtual account may be associated with the financial institution. Methods may include the payment API recording the funding of the virtual account in a ledger of the financial institution. Methods may include the payment API providing a QR code to the receiving party for the latter to access the virtual account. Methods may include the receiving party leaving the metaverse and presenting the QR code to a commercial establishment to obtain value for the fiat currency funded to the virtual account.

### FIELD OF TECHNOLOGY

Aspects of the disclosure relate to currency transfer in the metaverse. Specifically, aspects of the disclosure relate to cryptocurrency transfer in the metaverse.

### BACKGROUND OF THE DISCLOSURE

The metaverse provides an opportunity for people to communicate and experience things far beyond their local environment. They can share these experiences with others using special equipment such as headsets and goggles, gathering in the metaverse to make community.

Participants in the metaverse may want to exchange things of value through the metaverse. This is difficult considering the physical distance that may exist between the two parties.

It would be advantageous for parties participating in the metaverse to be able to exchange things of monetary value with each other.

It would also be advantageous to be able to share things of value, regardless of the relative financial status of the giving party and receiving party. However, it is unclear how the two parties would exchange something of value in the metaverse. Added to this is that one or both parties may not have access to financial resources due to a range of factors.

It would be desirable, therefore, to provide systems and methods to allow for the exchange of monetary value in the metaverse.

### SUMMARY OF THE DISCLOSURE

Aspects of the disclosure may relate to apparatus and methods for transferring currency in the metaverse.

Aspects of the disclosure may relate to apparatus and methods for transferring cryptocurrency in the metaverse.

Aspects of the disclosure may relate to apparatus and methods for transferring currency and/or cryptocurrency to an unbanked recipient in the metaverse.

Aspects of the disclosure may provide for managing risk when a recipient of currency in the metaverse is unbanked.

Apparatus and methods are herein provided to meet the above outlined objectives of the invention.

Methods may include transferring a cryptocurrency owned by a first party to a second party in the metaverse. Methods may include receiving a request to transfer cryptocurrency from one party to another party. Methods may include receiving the request at a payment application programming interface (API) of a financial institution operating in the metaverse. Methods may include where both parties are in the metaverse. Methods may include where the receiving party is unbanked.

Methods may include the payment API receiving the cryptocurrency from the first party. Methods may include the payment API charging a financial instrument with the cryptocurrency, where the financial instrument is associated with a financial institution. In this context, charging may refer to a population of the financial instrument with the cryptocurrency. Methods may include the payment API recording the charging of the financial instrument with the cryptocurrency in a ledger of the financial institution.

Methods may include the payment API transferring the financial instrument to a digital wallet associated with the receiving party. Methods may include the receiving party leaving the metaverse. Methods may include the receiving party presenting the financial instrument to a broker engine of another financial institution. The broker engine may also be called a broker. Methods may include the receiving party receiving fiat currency from the broker engine. Methods may include the financial institution recording receipt of the fiat currency by the receiving party in a ledger. Methods may include the financial institution providing the receiving party with paper money, coins, or paper money and coins.

Methods may include where an upper limit is placed on how much cryptocurrency is transferred to the receiving party's digital wallet.

Methods may include where an upper limit is placed on a total amount of cryptocurrency transferred from the transmitting party to the receiving party over a period.

Methods may include where both financial institutions are the same financial institution.

Methods may include where the financial instrument is a debit card.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 is a block diagram of apparatus in accordance with principles of the disclosure;

FIG. 2 is a block diagram of apparatus in accordance with principles of the disclosure;

FIG. 3 is a block diagram of apparatus in accordance with principles of the disclosure;

FIG. 4 is a block diagram of apparatus in accordance with principles of the disclosure;

FIG. 5 is a block diagram of apparatus in accordance with principles of the disclosure;

FIG. 6 is a block diagram of apparatus in accordance with principles of the disclosure;

FIG. 7 is a block diagram of apparatus in accordance with principles of the disclosure;

FIG. 8 is a block diagram of apparatus in accordance with principles of the disclosure;

FIG. 9 is a block diagram of apparatus in accordance with principles of the disclosure;

FIG. 10 is a block diagram of apparatus in accordance with principles of the disclosure; and

FIG. 11 shows an illustrative flowchart in accordance with principles of the disclosure.

### DETAILED DESCRIPTION OF THE DISCLOSURE

Aspects of the disclosure may relate to apparatus and methods for transferring currency in the metaverse.

Aspects of the disclosure may relate to various workflows for the transfer of currency in the metaverse. Transferring currency in the metaverse between parties may be accomplished through many different workflows. Some workflows may relate to the transfer of cryptocurrency in the metaverse. Some workflows may relate to the transfer of fiat currency in the metaverse. Some workflows may relate to the transfer of cryptocurrency and fiat currency in the metaverse. Some workflows may relate to the transfer of cryptocurrency and/or fiat currency in the metaverse where both of the parties are banked. Some workflows may relate to the transfer of cryptocurrency and/or fiat currency in the metaverse where one of the parties is banked and one of the parties is unbanked. For example, the transmitting party may be banked while the receiving party may be unbanked. Alternatively, the transmitting party may be unbanked while the receiving party may be banked. Workflows are presented in a summary form and then in more detail.

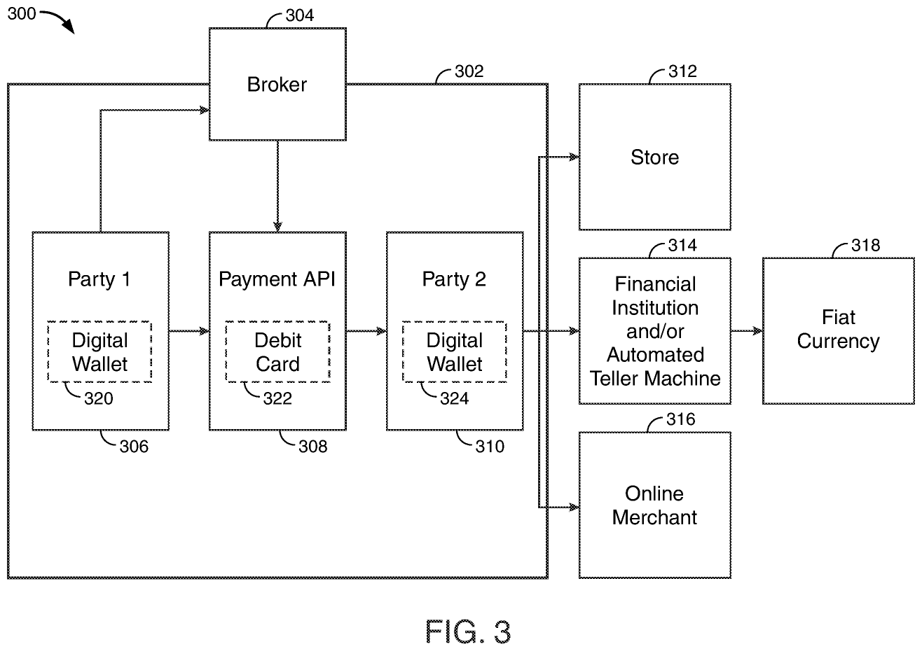

A first workflow may involve the originating party transmitting cryptocurrency and the receiving party receiving fiat currency, with both parties being in the metaverse. The cryptocurrency is converted into fiat currency the metaverse. Exemplary FIG. 3 may illustrate aspects of this workflow.

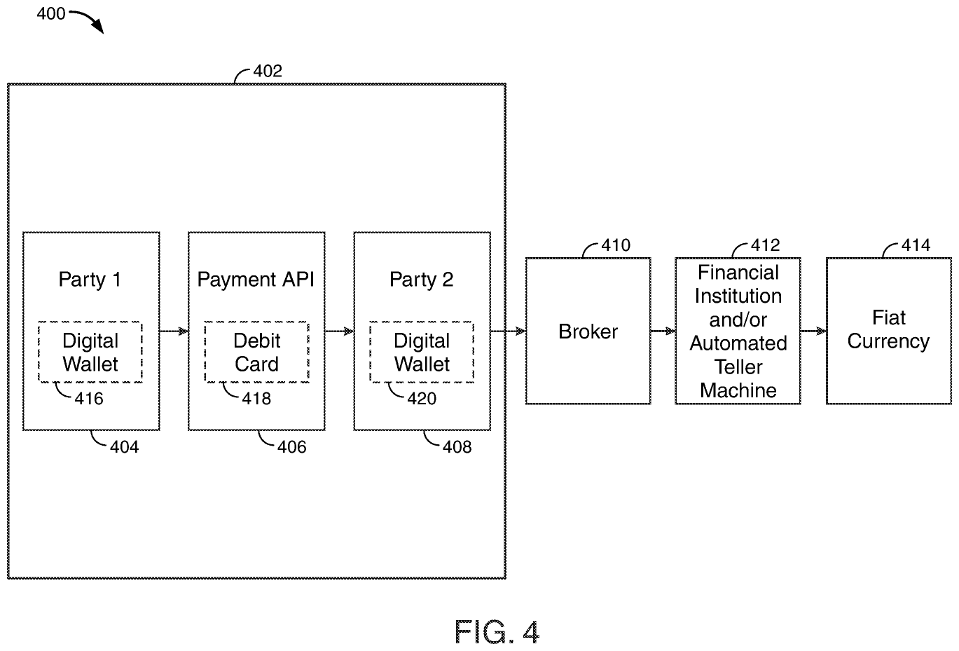

A second workflow may involve the originating party transmitting cryptocurrency and the receiving party receiving cryptocurrency, with both parties being in the metaverse. The receiving party may extract or pull out the cryptocurrency from the metaverse and convert it into fiat currency outside of the metaverse. Exemplary FIG. 4 may illustrate aspects of this workflow.

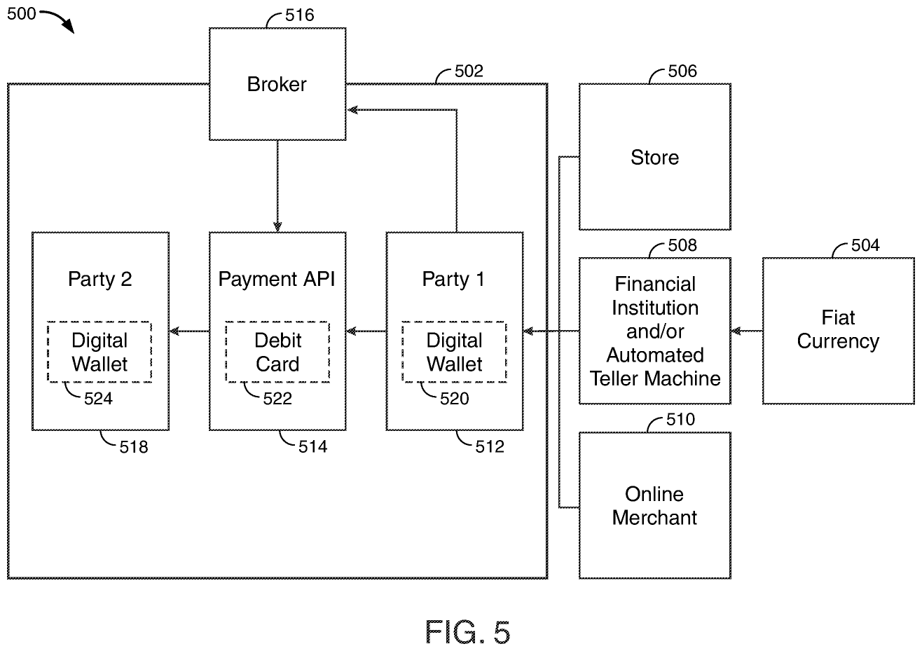

A third workflow may reverse the first workflow. This workflow may involve the originating party transmitting fiat currency and the receiving party receiving cryptocurrency, with both parties being in the metaverse. The fiat currency may be received from outside the metaverse and may be converted into cryptocurrency in the metaverse. Exemplary FIG. 5 may illustrate aspects of this workflow.

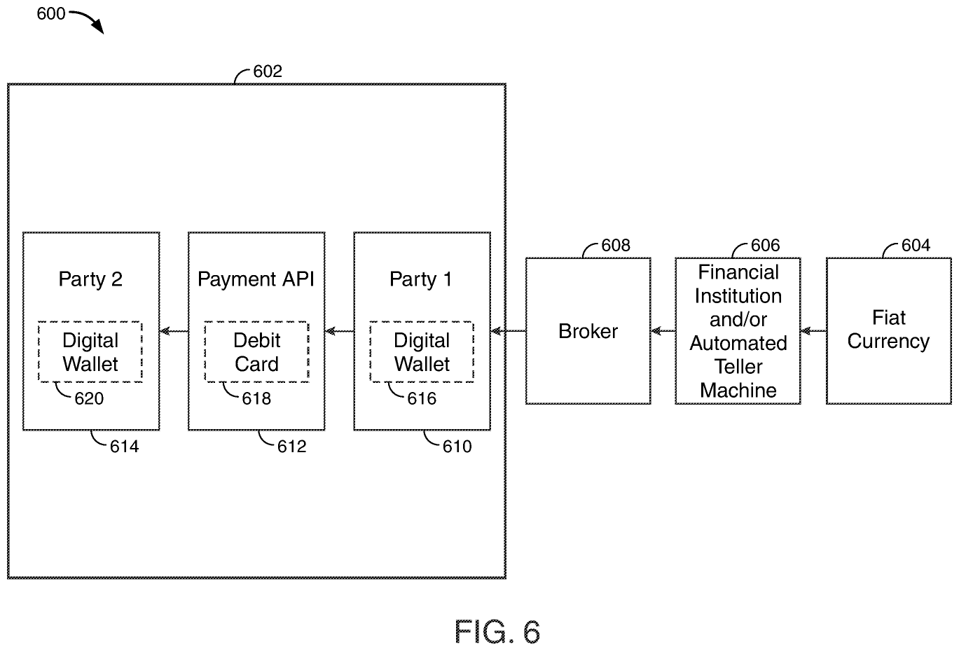

A fourth workflow may reverse the second workflow. This workflow may involve the originating party transmitting cryptocurrency and the receiving party receiving cryptocurrency, with both parties being in the metaverse. The transmitting party may receive cryptocurrency which was converted from fiat currency outside the metaverse. Exemplary FIG. 6 may illustrate aspects of this workflow.

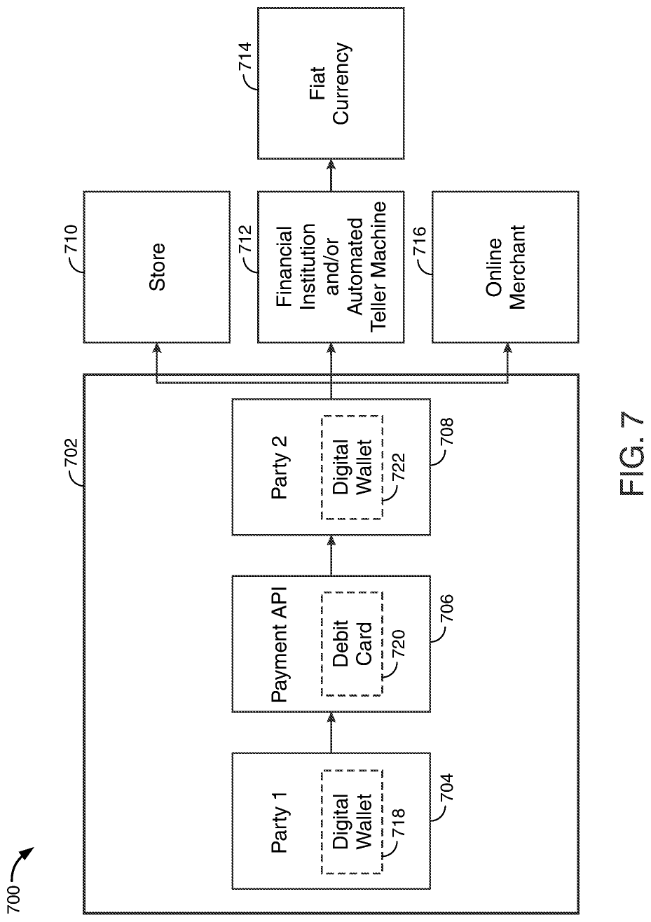

A fifth workflow may involve the originating party transmitting fiat currency and the receiving party receiving fiat currency, with both parties being in the metaverse. The receiving party may extract or pull out the fiat currency from the metaverse and utilize it outside the metaverse. Exemplary FIG. 7 may illustrate aspects of this workflow.

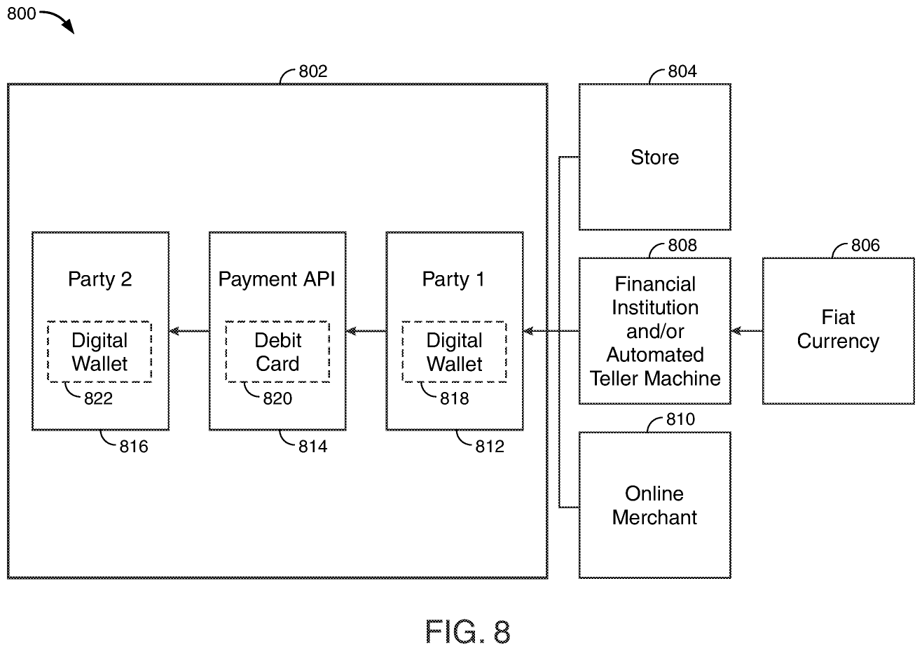

A sixth workflow may reverse the fifth workflow. This workflow may involve the originating party transmitting fiat currency and the receiving party receiving fiat currency, with both parties being in the metaverse. The fiat currency may be received by the originating party from outside the metaverse. Exemplary FIG. 8 may illustrate aspects of this workflow.

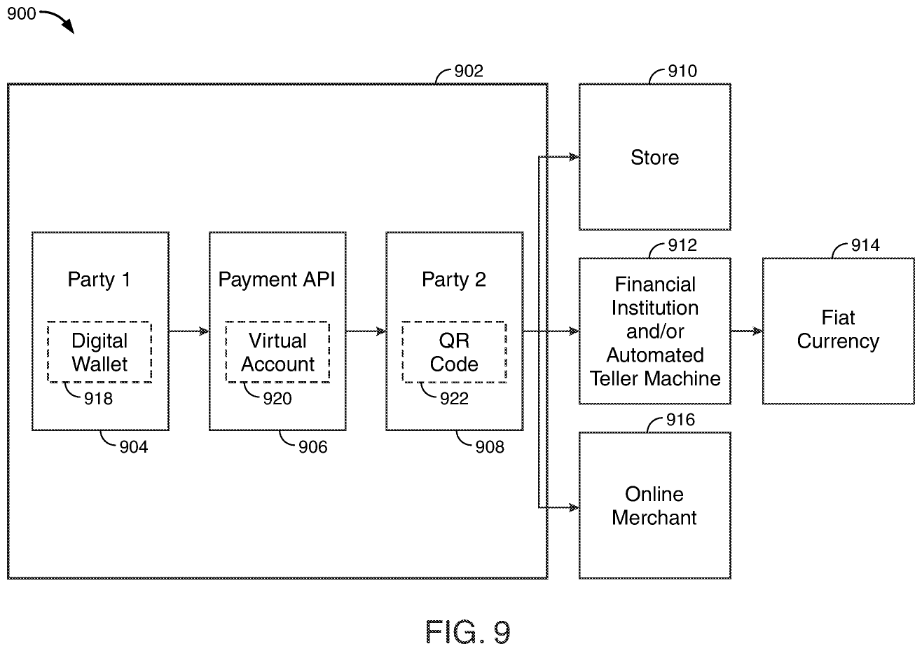

A seventh workflow may involve the originating party transmitting fiat currency and the receiving party receiving fiat currency, with both parties being in the metaverse. The receiving party may extract or pull out the fiat currency from the metaverse and utilize it outside the metaverse. Exemplary FIG. 9 may illustrate aspects of this workflow.

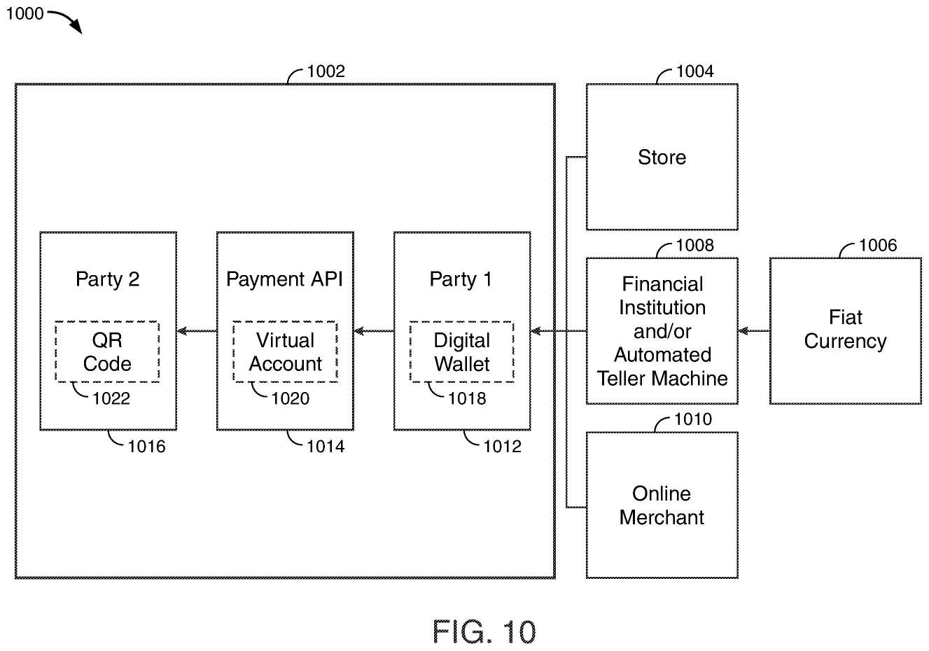

An eighth workflow may reverse the seventh workflow. This workflow may involve the originating party transmitting fiat currency and the receiving party receiving fiat currency, with both parties being in the metaverse. The transmitting party may receive fiat currency from outside the metaverse and bring it into the metaverse. Exemplary FIG. 10 may illustrate aspects of this workflow.

The metaverse may refer to an immersive virtual world in which the participants may interact with each other using virtual-reality headsets and/or specialized glasses. In the first workflow in the metaverse, party 1 may possess cryptocurrency and want to transfer value to party 2 such that party 2 receives the value as a fiat currency. Cryptocurrency may refer to a digital currency where the transactions are first verified and then recorded in a maintained ledger. Cryptocurrency may utilize a decentralized system which uses cryptography instead of utilizing centralized authority. Fiat currency is a currency that a government may issue. Fiat currency may be a government issued currency that is not backed by a commodity such as gold.

Party 1 may transfer the cryptocurrency to a broker engine, which may be referred to as a broker, in the metaverse, such as a cryptocurrency broker, for the broker to convert the cryptocurrency into a fiat currency. The cryptocurrency broker may be a financial institution, such as a bank. For example, party 1 may possess a digital wallet and transmit cryptocurrency from the digital wallet to the broker using a sub-screen in the metaverse. A digital wallet, which may be called an electronic wallet, may be a financial transaction application which may run on a device such as a smart phone. The broker may put the fiat currency onto a debit card. A debit card may be a card issued by a financial institution such as a bank which allows the holder to transfer money electronically to another person. For example, the debit card may be one of a financial institution like a bank. A financial institution may be a company that focuses on dealing with financial transactions, for example, deposits, loans, and investments.

The transferring of money from a cryptocurrency to a fiat currency and/or the depositing of the fiat currency onto the debit card may appear on the ledger of the financial institution, such as a bank, issuing the debit card. A ledger may be a record-keeping system for an organization's financial data. A clearinghouse may serve as an intermediary between party 1 and the broker and/or between party 1 and the financial institution. A clearinghouse may validate and finalize transactions, ensuring both parties involved comply with their obligations. For extra security to complement the request by party 1 to the broker to create a debit card with the converted funds, party 1 may inform the payment API tasked with creating the debit card as requested by party 1. A payment API may be a program that enables ecommerce entities to manage payments seamlessly. Party 1 may transfer the debit card to party 2 in the metaverse. For example, party 1 may hand the debit card to party 2 in the metaverse. Party 2 may put the debit card into their backpack. A backpack may represent a way for a party to hold onto more objects in the metaverse than their metaverse hands may hold. The backpack may recognize the debit card as a financial instrument and associate it with a digital wallet of party 2.

A backpack may a visual representation in the metaverse of a storage capacity a party possesses. Various tools which the party possesses, but is not actively using, may be stored in their backpack. The backpack may recognize the debit card as a financial instrument and associate it with a digital wallet of party 2.

An example of a financial instrument is a debit card. Another example of a financial instrument is a quick response (QR) code. A QR code is a type of barcode which may store information and be read by a digital device such as a smart phone. A financial instrument may serve as a holder, surrogate, or representation of fiat currency or other currency.

Party 2 may leave the metaverse and present their digital wallet to a financial institution and/or an automated teller machine (ATM) to receive fiat currency, such as paper and/or coinage fiat currency. An ATM may be an electronic device which enables a customer of a financial institution to deposit or withdraw funds. The digital wallet may communicate with the ATM with near field communication (NFC). The digital wallet may communicate with the ATM by generating a QR code. For example, the ATM may be an ATM that operates with fiat currency that provides paper and/or coinage fiat currency. Alternatively, party 2 may directly make a purchase with the digital wallet at a brick-and-mortar store or with an online merchant.

This first workflow allows a cryptocurrency-holding party to transfer money to another party while minimizing exposure to volatility associated with cryptocurrency. For example, to reduce exposure to risk of fluctuation of money under its control, a financial institution may want to minimize the time in which they control cryptocurrency. This is accomplished by converting the cryptocurrency into a fiat currency early in the exchange, where fiat currency is associated with less volatility than cryptocurrency.

Party 1 may be banked, which may mean that party 1 has a bank account. Party 2 may be banked. Party 2 may be unbanked, which may mean that party 2 does not have a bank account. A party may be unbanked because of choice or because the party does not qualify for establishing a bank account. A party may not qualify for a bank account due to a range of factors. When party 2 is unbanked, the payment API may not allow transfer of the debit card to party 2. When party 2 is unbanked, the payment API may allow transfer of the debit card to party 2 only if the amount of money being transferred in one transaction is below a certain threshold. When party 2 is unbanked, the payment API may allow transfer of the debit card to party 2 only if the amount of money being transferred in a period is cumulatively below a certain threshold. The period may be a week. The period may be a month or 30 days. The period may be a quarter, 3 months, or 90 days.

The second workflow for transferring currency in the metaverse where party 1 possesses a cryptocurrency and party 2 wants fiat currency may be described. Party 1 may transfer the cryptocurrency using, for example, a payment API to a financial institution, such as a bank, to create a cryptocurrency debit card. This may be selected by party 1 selecting a sub-screen in the metaverse to create the debit card. A financial institution, such as a bank, may record the generation of the cryptocurrency debit card in their ledger. Party 1 may transfer the debit card to party 2 in the metaverse. For example, party 1 may hand the debit card to party 2 in the metaverse. Party 2 may put the debit card into their backpack. The backpack may recognize the debit card as a financial instrument and associate it with a digital wallet of party 2. Party 2 may leave the metaverse and present their digital wallet containing the cryptocurrency debit card to a broker, such as a cryptocurrency broker. The cryptocurrency broker may be a financial institution, such as a bank. The broker may convert the cryptocurrency into a fiat currency. The broker may place fiat currency onto the debit card. The broker may send a request to an ATM to provide fiat currency, such as paper and/or coinage fiat currency. The broker may provide the digital wallet of party 2 with the fiat currency, and party 2 may take the digital wallet to a financial institution and/or an ATM to obtain fiat currency. The digital wallet may communicate with the ATM with near field communication (NFC). The digital wallet may communicate with the ATM by generating a quick response (QR) code. For example, an ATM may be an ATM that operates with fiat currency. Alternatively, party 2 may directly make a purchase with the digital wallet.

This second workflow exposes party 2 to volatility associated with cryptocurrency. Party 2 may desire this volatility as the value of the debit card when converted to fiat currency may be greater than when the cryptocurrency was received by party 2. Alternatively, using a stable cryptocurrency may reduce volatility. The cryptocurrency may be bitcoin. The cryptocurrency may be Ethereum. The cryptocurrency may be a cryptocurrency issued by a federal bank. For example, the cryptocurrency may be tied to U.S. Federal Reserve. For example, the cryptocurrency may be a Central Bank Digital Currency (CBDC) cryptocurrency. Cryptocurrency may be a Fed Coin. The cryptocurrency may be tied to a fiat currency, which may reduce the volatility of the cryptocurrency.

Party 1 may be banked. Party 2 may be banked. Party 1 may be unbanked. Party 2 may be unbanked. When party 2 is unbanked, the payment API may not allow transfer of the debit card to party 2. When party 2 is unbanked, the payment API may allow transfer of the debit card to party 2 only if the amount of money being transferred in one transaction is below a certain threshold. When party 2 is unbanked, the payment API may allow transfer of the debit card to party 2 only if the amount of money being transferred in a period is cumulatively below a certain threshold. The period may be a week. The period may be a month or 30 days. The period may be a quarter, 3 months, or 90 days.

The direction for flow of money in the first workflow may be reversed, which may result in the third workflow. Fiat currency may be loaded into a digital wallet of party 1. The fiat currency may come from paper money and/or coinage which is deposited at a financial institution and/or an ATM. The financial institution and/or ATM may communicate with the digital wallet with near field communication (NFC). The financial institution such as a bank and/or an ATM may communicate with the digital wallet by generating a QR code. The fiat currency may come from a credit from a store such as a brick-and-mortar store. The credit may result from a return. The fiat currency may come from a credit from an online merchant.

Party 1 may want to transfer value to party 2 such that party 2 receives the value as a cryptocurrency. Party 1 may transfer the fiat currency in its digital wallet to a broker in the metaverse, such as a cryptocurrency broker, for the broker to convert the fiat currency into a cryptocurrency. The cryptocurrency broker may be a financial institution, such as a bank. For example, party 1 may possess a digital wallet and transmit from the digital wallet fiat currency to the broker using a sub-screen in the metaverse. The broker may exchange the fiat currency into cryptocurrency and put the cryptocurrency onto a debit card. For example, the debit card may be one of a financial institution like a bank. The transferring of money from a fiat currency to a cryptocurrency and/or the depositing of the cryptocurrency onto the debit card may appear on the ledger of the financial institution, such as a bank, issuing the debit card. A clearinghouse may serve as an intermediary between party 1 and the broker and/or between party 1 and the financial institution. For extra security to complement the request by party 1 to the broker to create a debit card with the converted funds, party 1 may inform the payment API tasked with creating the debit card as requested by party 1. Party 1 may transfer the debit card to party 2 in the metaverse. For example, party 1 may hand the debit card to party 2 in the metaverse. Party 2 may put the debit card into their backpack. The backpack may recognize the debit card as a financial instrument and associate it with a digital wallet of party 2.

This third workflow allows party 1 to transfer a cryptocurrency to party 2 while minimizing their own contact with the cryptocurrency.

Party 1 may be banked. Party 2 may be banked. Party 2 may be unbanked. A party may be unbanked because of choice or because the party does not qualify for establishing a bank account. A party may not qualify for a bank account due to a range of factors. When party 2 is unbanked, the payment API may not allow transfer of the debit card to party 2. When party 2 is unbanked, the payment API may allow transfer of the debit card to party 2 only if the amount of money being transferred in one transaction is below a certain threshold. When party 2 is unbanked, the payment API may allow transfer of the debit card to party 2 only if the amount of money being transferred in a period is cumulatively below a certain threshold. The period may be a week. The period may be a month or 30 days. The period may be a quarter, 3 months, or 90 days.

The direction for flow of money in the second workflow may be reversed, which may result in the fourth workflow. Fiat currency such a paper money and/or coinage may be deposited with a financial institution such as a bank and/or at an ATM. The financial institution and/or ATM may provide the fiat currency, stored electronically, to a broker to exchange the fiat currency into cryptocurrency. The broker may be a financial institution such as a bank. The broker may be another entity that performs the exchange. A clearinghouse may serve as an intermediary between the broker and party 1 and/or between financial institutions and party 1. The cryptocurrency may be deposited into a digital wallet of party 1 by the broker in the metaverse. The digital wallet may communicate with the ATM with near field communication (NFC). The digital wallet may communicate with the ATM by generating a quick response code (QR code). Party 1 may transfer the cryptocurrency onto a debit card in the metaverse to transfer the debit card into a digital wallet of party 2. The debit card may be issued by a financial institution such as a bank. A financial institution, such as a bank, may record the generation of the cryptocurrency debit card in their ledger. The digital wallet may be in a backpack of party 2.

This fourth workflow allows a fiat currency-holding party to transfer money to another party in the metaverse. Party 1 may be banked. Party 2 may be banked. Party 2 may be unbanked. A party may be unbanked because of choice or because the party does not qualify for establishing a bank account. A party may not qualify for a bank account due to a range of factors. When party 2 is unbanked, the payment API may not allow transfer of the debit card to party 2. When party 2 is unbanked, the payment API may allow transfer of the debit card to party 2 only if the amount of money being transferred in one transaction is below a certain threshold. When party 2 is unbanked, the payment API may allow transfer of the debit card to party 2 only if the amount of money being transferred in a period is cumulatively below a certain threshold. The period may be a week. The period may be a month or 30 days. The period may be a quarter, 3 months, or 90 days.

In the fifth workflow in the metaverse, party 1 may possess a fiat currency and want to transfer value to party 2 such that party 2 receives the value as a fiat currency. Party 1 may transfer the fiat currency in the metaverse to a financial institution such as a bank to create a fiat currency debit card. For example, party 1 may possess a digital wallet and transmit from the digital wallet fiat currency to the financial institution using a sub-screen in the metaverse.

The financial institution may put the fiat currency onto a debit card. For example, the debit card may be one of a financial institution like a bank. The transferring of money from the digital wallet of party 1 onto the debit card of the financial institution may appear on the ledger of the financial institution, such as a bank, issuing the debit card. A clearinghouse may serve as an intermediary between party 1 and the financial institution. For extra security to complement the request by party 1 to the financial institution to create a debit card with the fiat currency, party 1 may inform the payment API tasked with creating the debit card as requested by party 1.

Party 1 may transfer the debit card to party 2 in the metaverse. For example, party 1 may hand the debit card to party 2 in the metaverse. Party 2 may put the debit card into their backpack. The backpack may recognize the debit card as a financial instrument and associate it with a digital wallet of party 2. Party 2 may leave the metaverse and present their digital wallet to a financial institution and/or an ATM to receive fiat currency, such as paper and/or coinage fiat currency. The digital wallet may communicate with the ATM with near field communication (NFC). The digital wallet may communicate with the ATM by generating a QR code. For example, the ATM may be an ATM that operates with fiat currency that provides paper and/or coinage fiat currency. Alternatively, party 2 may directly make a purchase with the digital wallet at a brick-and-mortar store or with an online merchant.

This fifth workflow allows a fiat currency-holding party to transfer money to another party in the metaverse. Party 1 may be banked. Party 2 may be banked. Party 2 may be unbanked. A party may be unbanked because of choice or because the party does not qualify for establishing a bank account. A party may not qualify for a bank account due to a range of factors. When party 2 is unbanked, the payment API may not allow transfer of the debit card to party 2. When party 2 is unbanked, the payment API may allow transfer of the debit card to party 2 only if the amount of money being transferred in one transaction is below a certain threshold. When party 2 is unbanked, the payment API may allow transfer of the debit card to party 2 only if the amount of money being transferred in a period is cumulatively below a certain threshold. The period may be a week. The period may be a month or 30 days. The period may be a quarter, 3 months, or 90 days.

The direction for flow of money in the fifth workflow may be reversed, which may result in the sixth workflow. In the sixth workflow in the metaverse, party 1 may possess a fiat currency and want to transfer value to party 2 such that party 2 receives the value as a fiat currency. Fiat currency may be loaded into a digital wallet of party 1 in the metaverse. The fiat currency may come from paper money and/or coinage which is deposited at a financial institution such as a bank and/or an ATM. The financial institution and/or ATM may communicate with the digital wallet with near field communication (NFC). The financial institution such as a bank and/or an ATM may communicate with the digital wallet by generating a quick response code (QR code). The fiat currency may come from a credit from a store such as a brick-and-mortar store. The credit may result from a return. The fiat currency may come from a credit from an online merchant.

Party 1 may transfer the fiat currency in its digital wallet onto a debit card in the metaverse for the purpose of transferring the debit card into a digital wallet of party 2. The debit card may be issued by a financial institution such as a bank. A financial institution, such as a bank, may record the generation of the cryptocurrency debit card in their ledger. Party 1 may transfer the debit card to party 2 in the metaverse. For example, party 1 may hand the debit card to party 2 in the metaverse. Party 2 may put the debit card into their backpack. The backpack may recognize the debit card as a financial instrument and associate it with a digital wallet of party 2.

This sixth workflow allows a fiat currency-holding party to transfer money to another party in the metaverse. Party 1 may be banked. Party 2 may be banked. Party 2 may be unbanked. A party may be unbanked because of choice or because the party does not qualify for establishing a bank account. A party may not qualify for a bank account due to a range of factors. When party 2 is unbanked, the payment API may not allow transfer of the debit card to party 2. When party 2 is unbanked, the payment API may allow transfer of the debit card to party 2 only if the amount of money being transferred in one transaction is below a certain threshold. When party 2 is unbanked, the payment API may allow transfer of the debit card to party 2 only if the amount of money being transferred in a period is cumulatively below a certain threshold. The period may be a week. The period may be a month or 30 days. The period may be a quarter, 3 months, or 90 days.

In the seventh workflow in the metaverse, party 1 may possess a fiat currency and want to transfer value to party 2 such that party 2 receives the value as a fiat currency. Party 1 may transfer the fiat currency in the metaverse to a financial institution such as a bank using a payment API to create a fiat currency-based virtual account. For example, party 1 may possess a digital wallet and transmit from the digital wallet fiat currency to the financial institution using a sub-screen in the metaverse which represents a payment API. The payment API and/or the financial institution may create a virtual account.

A clearinghouse may serve as an intermediary between party 1 and the financial institution. For extra security to complement the request by party 1 to the financial institution to create a virtual account with the fiat currency, party 1 may inform the payment API and/or the financial institution tasked with creating the virtual account as requested by party 1. This extra step may serve as a second step of verification that of the integrity of the request to make the virtual account.

The payment API and/or financial institution, at the request of party 1, may transfer the fiat currency to party 2 in the metaverse. The transfer may be accomplished by providing party 2 with a QR code. Party 2 may put the QR code in its backpack. The backpack may recognize the QR code as a financial instrument and associate it with a digital wallet of party 2. Alternatively, party 2 may simply keep the QR code for the next step.

Party 2 may leave the metaverse and present their digital wallet and/or QR code to a financial institution and/or an ATM to receive fiat currency, such as paper and/or coinage fiat currency. The digital wallet and/or QR code may communicate with the ATM with near field communication (NFC). The digital wallet and/or QR code may communicate with the ATM by generating a QR code. For example, the ATM may be an ATM that operates with fiat currency that provides paper and/or coinage fiat currency. Alternatively, party 2 may directly make a purchase with the digital wallet at a brick-and-mortar store or with an online merchant.

This seventh workflow allows a fiat currency-holding party to transfer money to another party in the metaverse. Party 1 may be banked. Party 2 may be banked. Party 2 may be unbanked. A party may be unbanked because of choice or because the party does not qualify for establishing a bank account. A party may not qualify for a bank account due to a range of factors. When party 2 is unbanked, the payment API may not allow transfer of the debit card to party 2. When party 2 is unbanked, the payment API may allow transfer of the debit card to party 2 only if the amount of money being transferred in one transaction is below a certain threshold. When party 2 is unbanked, the payment API may allow transfer of the debit card to party 2 only if the amount of money being transferred in a period is cumulatively below a certain threshold. The period may be a week. The period may be a month or 30 days. The period may be a quarter, 3 months, or 90 days.

The direction for flow of money in the seventh workflow may be reversed, which may result in the eighth workflow. In the eighth workflow in the metaverse, party 1 may possess a fiat currency and want to transfer value to party 2 such that party 2 receives the value as a fiat currency. Fiat currency may be loaded into a digital wallet of party 1 in the metaverse. The fiat currency may come from paper money and/or coinage which is deposited at a financial institution such as a bank and/or an ATM. The financial institution and/or ATM may communicate with the digital wallet with near field communication (NFC). The financial institution such as a bank and/or an ATM may communicate with the digital wallet by generating a QR code. The fiat currency may come from a credit from a store such as a brick-and-mortar store. The credit may result from a return. The fiat currency may come from a credit from an online merchant.

Party 1 may transfer the fiat currency in its digital wallet into a virtual account in the metaverse, for example, using a payment API for the purpose of transferring fiat currency into a digital wallet of party 2. The virtual account may be at a financial institution such as a bank. The financial institution, such as a bank, may record the generation of the virtual account in their ledger. Party 1 may transfer the fiat currency to party 2 in the metaverse. For example, party 1 may instruct a payment API to provide party 2 with access to the virtual account. The payment API may accomplish this by providing party 2 with a QR code. Party 2 may put the access information and/or QR code into their backpack. The backpack may recognize the QR code as a financial instrument and associate it with a digital wallet of party 2.

This eighth workflow allows a fiat currency-holding party to transfer fiat currency to another party in the metaverse. Party 1 may be banked. Party 2 may be banked. Party 2 may be unbanked. A party may be unbanked because of choice or because the party does not qualify for establishing a bank account. A party may not qualify for a bank account due to a range of factors. When party 2 is unbanked, the payment API may not allow transfer of the debit card to party 2. When party 2 is unbanked, the payment API may allow transfer of the debit card to party 2 only if the amount of money being transferred in one transaction is below a certain threshold. When party 2 is unbanked, the payment API may allow transfer of the debit card to party 2 only if the amount of money being transferred in a period is cumulatively below a certain threshold. The period may be a week. The period may be a month or 30 days. The period may be a quarter, 3 months, or 90 days.

Aspects of the disclosure may relate to apparatus and methods for transferring currency in the metaverse. Aspects of the disclosure may relate to apparatus and methods for transferring cryptocurrency in the metaverse. Aspects of the disclosure may relate to apparatus and methods for transferring cryptocurrency and/or fiat currency in the metaverse to a party who is unbanked. Aspects of the disclosure may relate to apparatus and methods for transferring cryptocurrency and/or fiat currency in the metaverse, and the receiving party using the received currency in the real world, i.e., the world outside of the metaverse.

Methods may involve converting a cryptocurrency owned by a transmitting party into a fiat currency to be received by a receiving party, both parties may be in the metaverse. Methods may involve a payment API of a financial institution operating in the metaverse receiving a request to transfer and convert cryptocurrency of the transmitting party to fiat currency for the receiving party. Methods may involve where both parties are in the metaverse. Methods may involve where the second party is unbanked.

Methods may involve the payment API transferring the cryptocurrency from a digital wallet associated with the transmitting party to a broker engine of a financial institution. Methods may involve the payment API receiving a value of the cryptocurrency as fiat currency from the broker engine. Methods may involve the payment API charging a financial instrument with the fiat currency, where the financial instrument is associated with the financial institution. In this context, charging may refer to a population of the financial instrument with the fiat currency.

Methods may include the payment API recording the charging of the financial instrument with the fiat currency on a ledger of the financial institution. Methods may include the payment API transferring the financial instrument to a digital wallet associated with the receiving party. Methods may include, when the receiving party leaves the metaverse, the receiving party presents their digital wallet to a commercial establishment outside of the metaverse to obtain value for the fiat currency charged to the financial instrument.

Methods may include where an upper limit is placed on how much fiat currency is transferred to the receiving party's digital wallet. Methods may include where an upper limit is placed on how much cryptocurrency is transferred to the receiving party's digital wallet.

Methods may include where an upper limit is placed on a total amount of fiat currency transferred from the transmitting party to the receiving party over a period. Methods may include where an upper limit is placed on a total amount of cryptocurrency transferred from the transmitting party to the receiving party over a period.

Methods may include where the commercial establishment is a financial institution. The financial institution may provide the receiving party with paper money, coins, or paper money and coins.

Methods may include where the commercial establishment is a store that accepts payment from the receiving party's digital wallet.

Methods may include where the commercial establishment is an online establishment that accepts payment from the receiving party's digital wallet.

Methods may include where the financial institutions are the same financial institution.

Methods may include where the financial instrument is a debit card.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

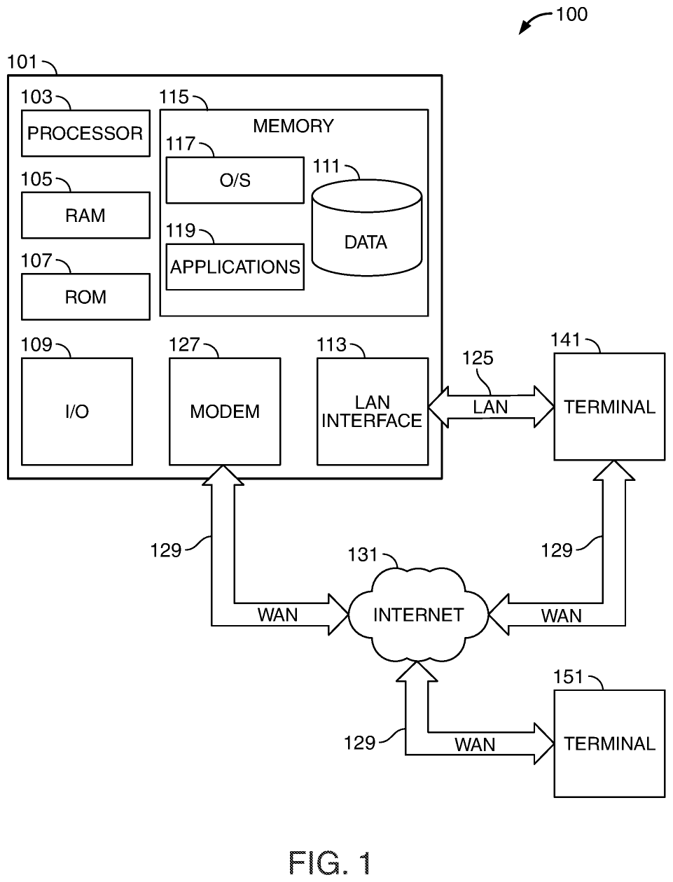

FIG. 1 shows an illustrative block diagram of system 100 that includes computer 101. One may refer to Computer 101 as an “engine,” “server” or “computing device.” Computer 101 may be a workstation, desktop, laptop, tablet, smart phone, or any other suitable computing device. One may use elements of system 100, including computer 101, to implement various aspects of the systems and methods disclosed herein.

Computer 101 may have processor 103 for controlling operation of the device and its associated components, and may include RAM 105, ROM 107, input/output module 109, and non-transitory/non-volatile machine-readable/writeable memory 115. One may configure machine-readable/writeable memory to store information in machine-readable/writeable data structures. Processor 103 may also execute all software running on the computer—e.g., an operating system and/or voice recognition software. Other components commonly used for computers, such as EEPROM or Flash memory or any other suitable components, may also be part of computer 101.

Memory 115 may be comprised of any suitable permanent storage technology—e.g., a hard drive. Memory 115 may store software including operating system 117 and application program(s) 119 along with any data 111 needed for operation of system 100. Memory 115 may also store videos, text, and/or audio assistance files. One may store data in memory 115, in cache memory, or in any other suitable memory.

Input/output (“I/O”) module 109 may include connectivity to a microphone, keyboard, touch screen, mouse, and/or stylus. One may provide input into computer 101 through these I/O modules. The input may include input relating to cursor movement. I/O 109 may also include one or more speakers for providing audio output and a video display device for providing textual, audio, audiovisual, and/or graphical output. The input and/or output may be related to computer application functionality.

One may connect System 100 to other systems via local area network (LAN) interface (or adapter) 113. System 100 may operate in a networked environment supporting connections to one or more remote computers, such as terminals 141 and 151. Terminals 141 and 151 may be personal computers or servers that include many or all the elements described above relative to system 100. Network connections depicted in FIG. 1 include a local area network (LAN) 125 and a wide area network (WAN) 129 but may also include other networks. One may connect computer 101 to LAN 125 through LAN interface (or adapter) 113 when using a LAN networking environment. When used in a WAN networking environment, computer 101 may include modem 127 or other means for establishing communications over WAN 129, such as Internet 131.

One appreciates that the network connections shown are illustrative. One may use other means of establishing a communications link between computers. One may presume the existence of various well-known protocols such as TCP/IP, Ethernet, FTP, HTTP, and the like. One may operate the system in a client-server configuration to permit retrieval of data from a web-based server or application programming interface (API). One may understand that web-based, for this application, includes a cloud-based system. The web-based server may transmit data to any other suitable computer system. The web-based server may also send computer-readable instructions, together with data, to any suitable computer system. The computer-readable instructions may be to store data in cache memory, the hard drive, secondary memory, or any other suitable memory.

Additionally, one may use application program(s) 119 on computer 101. These programs may include computer executable instructions for invoking functionality related to communication, such as e-mail, Short Message Service (SMS), and voice input and speech recognition applications. One may refer to application program(s) 119 (alternatively, “plugins,” “applications,” or “apps”) to include computer executable instructions for invoking functionality related to performing various tasks. Application program(s) 119 may utilize one or more algorithms that process received executable instructions, perform power management routines or other suitable tasks. Application program(s) 119 may utilize one or more decisioning processes for the processing of calls received from calling sources as detailed herein.

Application program(s) 119 may include computer executable instructions (alternatively referred to as “programs”). Embodied in hardware or firmware (not shown) may be the computer executable instructions. Computer 101 may execute the instructions embodied by the application program(s) 119 to perform various functions.

Application program(s) 119 may utilize the computer-executable instructions executed by a processor. Programs include routines, programs, objects, components, data structures, etc. that perform tasks or implement abstract data types. A computing system may be operational with distributed computing environments. Remote processing may perform tasks on devices linked through a communications network. In a distributed computing environment, a program may be in both local and remote computer storage media including memory storage devices. Computing systems may rely on a network of remote servers hosted on the Internet to store, manage, and process data (e.g., “cloud computing” and/or “fog computing”).

Stored in memory 115 is any information described above in connection with database 111, and any other suitable information. One or more of application program(s) 119 may include one or more algorithms used to transfer currency in the metaverse. For example, an application program 119 may be used to transfer cryptocurrency in the metaverse. Alternatively, an application program 119 may be used to transfer fiat currency in the metaverse.

One may describe the invention in the context of computer-executable instructions, such as application program(s) 119, for execution by a computer. Programs may include routines, programs, objects, components, and data structures, which perform tasks or implement data types. One may practice the invention in distributed computing environments. One may perform tasks by remote processing devices, linked through a communications network. In a distributed computing environment, programs may be in both local and remote computer storage media including memory storage devices. One may consider such programs, for this application's purposes, as engines for the performance of the program-assigned tasks.

Computer 101 and/or terminals 141 and 151 may also include various other components, such as a battery, speaker, and/or antennas (not shown). One may link components of computer system 101 by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, Blackberry™, tablet, smartphone, or any other computing system for receiving, storing, transmitting and/or displaying relevant information. Terminal 151 and/or terminal 141 may be one or more user devices. Terminals 151 and 141 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

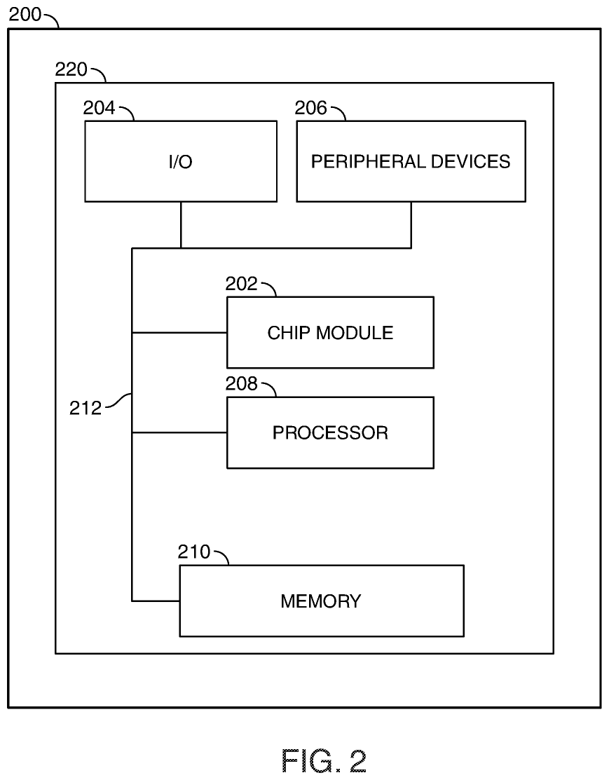

FIG. 2 shows an illustrative block diagram of apparatus 200. One may configure apparatus 200 in accordance with the principles of the disclosure. Apparatus 200 may be a computing device. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real time timers, power-on reset generators or any other suitable peripheral devices; logical processing device 208, which may compute data structural information and structural parameters of data; and machine-readable/writeable memory 210.

One may configure machine-readable/writeable memory 210 to store information in machine-readable/writeable data structures, such as: machine executable instructions (for example, “computer instructions” or “computer code”); applications, signals; and/or any other suitable information or data structures.

One may couple together components 202, 204, 206, 208 and 210 by system bus (or other interconnections) 212 and may be present on one or more than one circuit board 220. In some embodiments, the components may be integrated into a single chip. The chip may be silicon-based.

FIG. 3 shows an illustrative block diagram 300 of apparatus in accordance with principles of the disclosure. The apparatus may partially or completely be within the metaverse 302. Party 1 306 may be within the metaverse 302 and want to transfer cryptocurrency from its digital wallet 320 to party 2 310. To affect a transfer, party 1 306 may contact a broker 304 to make the transfer. The broker 304 may be a financial institution such as a bank. A payment API 308 may facilitate the transfer of the cryptocurrency from the digital wallet 320 of party 1 306 to the broker 304, and/or from the broker 304 to the digital wallet 324 of party 2. For party 1 306 to affect the cryptocurrency transfer, they may select an icon within the metaverse 302 that indicates the broker 304. The payment API 308 working with the broker 304 may convert and/or exchange the cryptocurrency into fiat currency and charge a debit card 322 with the fiat currency. They may then transfer the debit card 322 into the digital wallet 324 of party 2 310. For party 2 310 to actualize the fiat currency in the real world, i.e., the world outside the metaverse 302, party 2 310 may use their digital wallet 324 at a brick-and-mortar store 312. Party 2 310 may use their digital wallet 324 at a financial institution and/or ATM 314, where they obtain paper and/or coin fiat currency 318. Party 2 310 may use their digital wallet 324 with an online merchant 316.

FIG. 4 shows an illustrative block diagram 400 of apparatus in accordance with principles of the disclosure. The apparatus may partially or completely be within the metaverse 402. Party 1 404 may be within the metaverse 402 and want to transfer cryptocurrency from its digital wallet 416 to party 2 408. A payment API 406 may facilitate the transfer of the cryptocurrency from the digital wallet 416 of party 1 404 to the debit card 418 of a financial institution. The payment API may then transfer the debit card 418 containing the cryptocurrency into the digital wallet 420 of party 2 408. For party 2 408 to convert the cryptocurrency into fiat currency, party 2 408 may leave the metaverse 402, and present its digital wallet to a broker 410. The broker 410 may be a financial institution such as a bank. The broker 410 may convert the cryptocurrency into fiat currency. The fiat currency may be presented to a financial institution and/or an ATM 412. The financial institutions may be the same. The financial institution and/or ATM 412 may provide party 2 with fiat currency such as paper money, coinage, or both.

FIG. 5 shows an illustrative block diagram 500 of apparatus in accordance with principles of the disclosure. Fiat currency may come to party 1 512 from the real world into the metaverse 502 by different pathways. The fiat currency may come from a refund in a store 506. The fiat currency may come from paper and/or coin fiat currency 504 deposited at a financial institution such as a bank and/or an ATM 508. The fiat currency may come from a refund by an online merchant 510. Regardless of entry point, the fiat currency may be transferred into the metaverse to a digital wallet 520 of party 1 512. Party 1 may transmit the fiat currency to a broker 516 to convert it into cryptocurrency. The broker 516 may be a financial institution such as a bank. A payment API 514 may facilitate the transfer of the fiat currency from the digital wallet 520 of party 1 512 to the broker 516, and/or from the broker 516 to a debit card 522. The debit card 522 may then be transferred to the digital wallet 524 of party 2 518 in the metaverse.

FIG. 6 shows an illustrative block diagram 600 of apparatus in accordance with principles of the disclosure. The apparatus may partially or completely be within the metaverse 602. Fiat currency 604 may be introduced to a financial institution and/or ATM 606. The financial institution and/or ATM 606 may then transmit the fiat currency to a broker 608 to convert the funds into cryptocurrency. The cryptocurrency may be provided into a digital wallet 616 of party 1 610 from the real world into the metaverse 602. The cryptocurrency may be transferred by a payment API 612 from the digital wallet 616 of party 1 onto a debit card 618 of a financial institution. The transfer may be recorded in a ledger of the financial institution. The payment API may then transfer the debit card 618 into digital wallet 620 of party 2 614.

FIG. 7 shows an illustrative block diagram 700 of apparatus in accordance with principles of the disclosure. The apparatus may partially or completely be within the metaverse 702. Party 1 704 may be within the metaverse 702 and want to transfer fiat currency from its digital wallet 718 to party 2 708. To affect a transfer, party 1 704 may contact a payment API 706 to create a debit card 720 holding fiat currency. The payment API 706 may connect to a financial institution such as a bank. A payment API 706 may facilitate the transfer of the fiat currency from the digital wallet 718 of party 1 704 to the digital wallet 722 of party 2 708. The payment API 706 may then transfer the debit card 720 into the digital wallet 722 of party 2 708. For party 2 708 to actualize the fiat currency in the real world, i.e., the world outside the metaverse 702, party 2 708 may use their digital wallet 722 at a brick-and-mortar store 710. Party 2 708 may use their digital wallet 722 at a financial institution and/or ATM 712, where they obtain paper and/or coin fiat currency 714. Party 2 708 may use their digital wallet 722 with an online merchant 716.

FIG. 8 shows an illustrative block diagram 800 of apparatus in accordance with principles of the disclosure. Fiat currency may come to party 1 812 from the real world into the metaverse 802 by different pathways. The fiat currency may come from a refund in a store 804. The fiat currency may come from paper and/or coin fiat currency 806 deposited at a financial institution such as a bank and/or an ATM 808. The fiat currency may come from a refund by an online merchant 810. Regardless of entry point, the fiat currency may be transferred into the metaverse to a digital wallet 818 of party 1 812. Party 1 may transmit the fiat currency to a payment API of a financial institution such as a bank 814 to create a fiat currency debit card 820. The payment API 814 may facilitate the transfer of the fiat currency from the digital wallet 818 of party 1 812 to the debit card 820. The debit card 820 may then be transferred to the digital wallet 822 of party 2 816 in the metaverse.

FIG. 9 shows an illustrative block diagram 900 of apparatus in accordance with principles of the disclosure. The apparatus may partially or completely be within the metaverse 902. Party 1 904 may be within the metaverse 902 and want to transfer fiat currency from its digital wallet 918 to party 2 908. To affect a transfer, party 1 904 may contact a payment API 906 to create a virtual account in the metaverse 920 holding fiat currency. The payment API 906 may connect to a financial institution such as a bank. A payment API 906 may facilitate the transfer of the fiat currency from the digital wallet 918 of party 1 904 to the digital wallet 922 of party 2 908. The payment API 906 may then transfer a QR code 922 to party 2 908 which links to the virtual account 920. For party 2 908 to actualize the fiat currency in the real world, i.e., the world outside the metaverse 902, party 2 908 may present the QR code 922 at a brick-and-mortar store 910. A payment API, either 908 or a different payment API, may link presented QR code 922 to the virtual account 920 and deliver the fiat currency to the store 910. Party 2 908 may present the QR code 922 at a financial institution and/or ATM 912, allowing one of the latter to use a payment API, either 908 or a different API, to the virtual account 920 and deliver the fiat currency to the financial institution and/or ATM 912, which can then provide paper and/or coin fiat currency 914. Party 2 908 may present the QR code 922 at an online merchant 916. A payment API, either 908 or a different payment API, may link presented QR code 922 to the virtual account 920 and deliver the fiat currency to online merchant 916.

FIG. 10 shows an illustrative block diagram 1000 of apparatus in accordance with principles of the disclosure. Fiat currency may come to party 1 1012 from the real world into the metaverse 1002 by different pathways. The fiat currency may come from a refund in a store 1004. The fiat currency may come from paper and/or coin fiat currency 1006 deposited at a financial institution such as a bank and/or an ATM 1008. The fiat currency may come from a refund by an online merchant 1010. Regardless of entry point, the fiat currency may be transferred into the metaverse to a digital wallet 1018 of party 1 1012. Party 1 1012 may transmit the fiat currency in its digital wallet 1018 to a payment API of a financial institution such as a bank 1014 to create a virtual account 1020. Payment API 1014 may facilitate the transfer of the fiat currency from the digital wallet 1018 of party 1 1012 to a QR code 1022 with party 2 1016 in the metaverse.

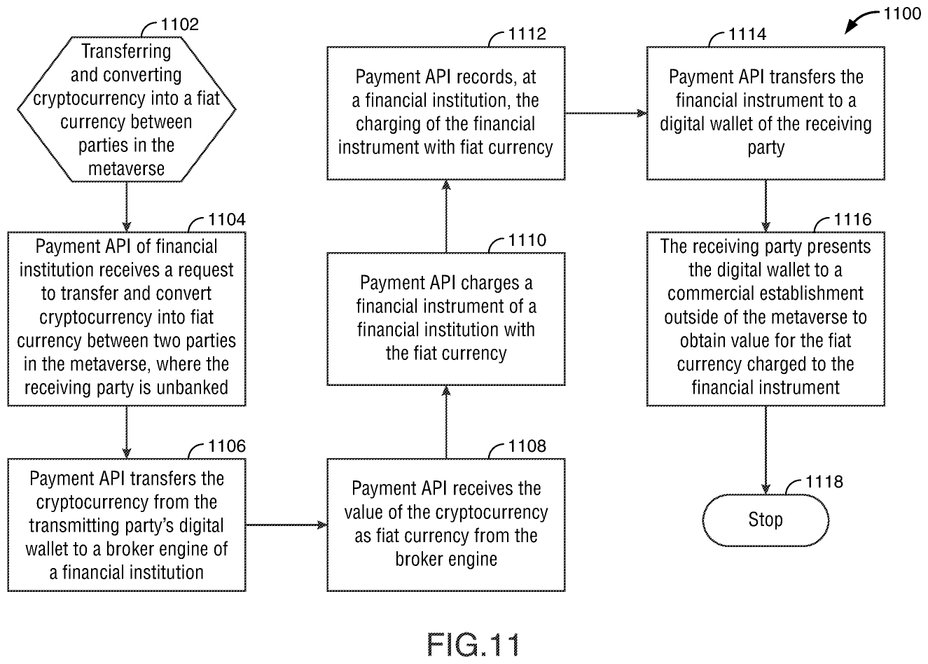

FIG. 11 shows an illustrative flowchart 1100. The flowchart may illustrate a method which may start at 1102. The method may illustrate transferring and converting a cryptocurrency into a fiat currency between parties in the metaverse. At step 1104, a payment API of a financial institution may receive a request to transfer and convert cryptocurrency into fiat currency between two parties in the metaverse, where the receiving party is unbanked. At step 1106, payment API may transfer the cryptocurrency from the transmitting party's digital wallet to a broker engine of a financial institution. At step 1108, payment API may receive the value of the cryptocurrency as fiat currency from the broker engine. At step 1110, payment API may charge a financial instrument of a financial institution with the fiat currency. At step 1112, payment API may record, at a financial institution, the charging of the financial instrument with fiat currency. At step 1114, payment API may transfer the financial instrument to a digital wallet of the receiving party. At step 1116, the receiving party may present the digital wallet to a commercial establishment outside of the metaverse to obtain value for the fiat currency charged to the financial instrument. At step 1118, the method may be completed.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and systems for transferring currency in the metaverse are provided. Persons skilled in the art will appreciate that the present invention can be practiced by other than the described embodiments, which are presented for purposes of illustration rather than of limitation, and that the present invention is limited only by the claims that follow.

1. A method of converting a cryptocurrency owned by a first party into a fiat currency to be received by a second party, in a metaverse, the method comprising:
receiving a request, at a payment application programming interface (API) of a first financial institution operating in the metaverse, to transfer and convert cryptocurrency at the first party to fiat currency at the second party, wherein:
i) the first party and second party are in the metaverse; and
ii) the second party is unbanked;
transferring, using the payment API, the cryptocurrency from a first digital wallet associated with the first party to a broker engine of a second financial institution;
receiving, by the payment API, a value of the cryptocurrency as fiat currency from the broker engine;
charging, using the payment API, a financial instrument with the fiat currency, wherein the financial instrument is associated with the first financial institution;
recording, using the payment API, the charging of the financial instrument with the fiat currency on a ledger of the first financial institution; and
transferring, using the payment API, the financial instrument to a second digital wallet associated with the second party, wherein when the second party leaves the metaverse, the second party presents the second digital wallet to a commercial establishment outside of the metaverse to obtain value for the fiat currency charged to the financial instrument.

2. The method of claim 1, wherein an upper limit is placed on how much fiat currency is transferred to the second digital wallet.

3. The method of claim 1, wherein an upper limit is placed on a total amount of fiat currency transferred from the first party to the second party over a period of time.

4. The method of claim 1, wherein the commercial establishment is a third financial institution, and the third financial institution provides the second party with paper money, coins, or paper money and coins.

5. The method of claim 1, wherein the commercial establishment is a store that accepts payment from the second digital wallet.

6. The method of claim 1, wherein the commercial establishment is an online establishment that accepts payment from the second digital wallet.

7. The method of claim 1, wherein the first financial institution and the second financial institution are one financial institution.

8. The method of claim 1, wherein the financial instrument is a debit card.

9. The method of claim 1, wherein the payment API may use a clearinghouse to facilitate a conversion of the cryptocurrency into fiat currency.

10. (canceled)
